(19) United States
(12) Patent Application Publication
(10) Pub. No.: US 2023/0118670 A1
(43) Pub. Date: Apr. 20, 2023

(54) METHOD FOR MANUFACTURING A TITANIUM FIRE-RESISTANT METAL COMPONENT BY ADDITIVE MANUFACTURING

(71) Applicant: SAFRAN AIRCRAFT ENGINES, Paris (FR)

(72) Inventors: Jonathan Leblanc, Moissy-Cramayel (FR); Hugo Jean-Louis Sistach, Moissy-Cramayel (FR)

(73) Assignee: SAFRAN AIRCRAFT ENGINES, Paris (FR)

(21) Appl. No.: 17/914,179

(22) PCT Filed: Mar. 9, 2021
(86) PCT No.: PCT/FR2021/050396

§ 371 Date: Sep. 23, 2022

(30) Foreign Application Priority Data
Mar. 25, 2020 (FR) FR2002932

(51) Int. Cl. B22F 10/64; B33Y 80/00; B33Y 10/00; C22F 1/18; B33Y 40/20; B22F 10/25; C23C 24/10

(52) U.S. Cl. CPC B22F 10/64; B33Y 80/00; B33Y 10/00; C22F 1/183; B33Y 40/20; B22F 10/25; C23C 24/106; B22F 2301/205; F01D 25/005

(57) ABSTRACT

A method for manufacturing a metal component includes the following steps: a shell made of a titanium-based material is provided, the shell having a first surface and a second surface remote from the first surface; a covering layer made of a titanium fire-resistant material is produced by additive manufacturing on the shell such that the covering layer at least partially covers the first surface and/or the second surface; and, after the additive manufacturing step, the metal component is heat treated at a temperature of between 200° C. and 1000° C.

### TECHNICAL FIELD

The present invention relates, in general, to a method for manufacturing metal components.

### PRIOR ART

Some components are made of a titanium alloy for the particular properties of these alloys, in particular mechanical resistance, temperature resistance but also corrosion resistance for a lower density than that of a steel or than that of another alloy such as those based on Nickel or based on Cobalt.

This is particularly the case for aeronautical components, for example turbomachinery components such as high-pressure compressor casings. In this case, the titanium component is a shell.

In the following description, a shell means a component of which one of the three dimensions (its thickness) in space is small (at least five times smaller) compared to the two other dimensions (its length and its width) perpendicular to this thickness. A shell thus contains a plate, a tube, a ferrule, a casing.

The term titanium is used hereafter to mean an alloy wherein titanium is the major element.

Such a component, generally used in a high temperature environment, must be able to withstand titanium fire, that is to say a catastrophic ignition of titanium in the event of a sudden rise in temperature.

In the case of high-pressure compressor casings, the risk of titanium fire is also increased by the friction between the casing and the blades it protects, formed of a titanium-based material.

Various solutions are currently used to prevent such inflammation of titanium. They consist in fixing to the titanium component a component made of another alloy (that is to say an alloy other than a titanium alloy), this component made of another alloy being intended to be exposed to higher temperatures and forming a screen between these high temperatures and the titanium component.

It is in particular known to fix the two components by hot rolling, by hydraulic plating or else by means of sockets.

However, these existing solutions have disadvantages.

Indeed, it is difficult to control the exact position of the interface between the titanium component and the component made of another alloy.

In addition, depending on the implementation tolerances, machining tolerances and machining strategies, the thickness of one or the other part is not always optimized. For example, it is often impossible for this interface to follow the final shape all along the titanium as close as possible to the ribs when the geometry of the titanium component is three-dimensional.

It is also impossible to control the thickness ratio between two materials (within tolerances).

In addition, when one of the above methods is used, the shear or peel resistance between the titanium component and the component made of another alloy is quite low. This shear resistance is particularly lower as the difference between the expansion coefficients of titanium and the other alloy is significant.

Also, the complexity, the number of steps allowing to fix the titanium component and the component made of another alloy according to these known methods and the need to machine the assembly formed by the two components after being assembled, mean that the cost of the method is high.

Patent application FR2 978 077 describes a method for assembling a first shell made of a titanium fire-resistant material and a second shell made of a titanium-based material.

The two shells are contacted with each other then heated. The second shell is deformed so as to match the shape of the first shell.

However, given the differences in expansion between the two materials considered, the risk of separation of the two components is significant.

### DESCRIPTION OF THE INVENTION

The object of the invention is therefore to overcome these disadvantages and to propose a method for manufacturing a metal component benefiting both from the low density of a titanium-based alloy and from titanium fire resistance.

A method for manufacturing a metal component is therefore proposed, the manufacturing method including the following steps:

a shell made of a titanium-based material is provided, the shell having a first surface and a second surface opposite the first surface;

a covering layer made of a titanium fire-resistant material is produced by additive manufacturing on the shell such that said covering layer at least partially covers the first surface and/or the second surface; and

after the additive manufacturing step, the metal component is heat treated at a temperature of between 200° C. and 1000° C.

According to one embodiment, the covering layer can be made of a material of formula NiCr19Fe19Nb5Mo3 and/or the shell can be made of a material of formula Ti6Al4V.

Advantageously, the heat treatment may comprise a plurality of steps.

Preferably, the heat treatment comprises a first step at a temperature of between 500° C. and 1000° C., preferably of between 700° C. and 1000° C., more preferably of between 930° C. and 950° C.

In addition, the first step can be carried out for a duration of between 10 min and 5 h, preferably of between 30 min and 2 h, more preferably of between 45 min and 1 h 30.

Preferably, the heat treatment can comprise a second step at a temperature of between 200° C. and 900° C., preferably of between 500° C. and 800° C. and more preferably of between 690° C. and 710° C.

The second step can be carried out for a duration of between 30 min and 9 h, preferably of between 6 h and 9 h, more preferably of between 7 h 30 and 8 h 30.

Furthermore, the manufacturing method may comprise the production of a plurality of intermediate layers disposed between the shell and the covering layer, the plurality of intermediate layers being formed of a mixture of the titanium fire-resistant material and the titanium-based material, said mixture forming a composition gradient such that the intermediate layer disposed directly in contact with the covering layer made of a titanium fire-resistant material being mainly formed of the titanium fire-resistant material and conversely, the intermediate layer disposed directly in contact with the shell made of a titanium-based material being mainly formed of the titanium-based material.

Preferably, the number of the plurality of intermediate layers is comprised between 4 and 20 layers, preferably comprised between 10 and 15 layers.

Advantageously, the plurality of intermediate layers can comprise three layers, each of the three layers respectively comprises, starting from the shell towards the covering layer, a proportion of titanium fire-resistant material/titanium-based material of: 30%/70%, 50%/50% and 70%/30%.

According to another embodiment, the plurality of intermediate layers can comprise three layers, each of the three layers respectively comprises, starting from the shell towards the covering layer, a proportion of titanium fire-resistant material/titanium-based material of: 25%/75%, 50%/50% and 75%/25%.

According to another embodiment, the plurality of intermediate layers may comprise nine layers, each of the nine layers respectively comprises, starting from the shell towards the covering layer, a proportion of titanium fire-resistant material/titanium-based material of: 10%/90%, 20%/80%, 30%/70%, 40%/60%, 50%/50%, 60%/40%, 70%/30%, 80%/20%, 90%/10%.

According to another embodiment, the plurality of intermediate layers can comprise nineteen layers, each of the nineteen layers respectively comprises, starting from the shell towards the covering layer, a proportion of titanium fire-resistant material/titanium-based material: 5%/95%, 10%/90%, 15%/85%, 20%/80%, 25%/75%, 30%/70%, 35%/65%, 40%/60%, 45%/55%, 50%/50%, 55%/45%, 60%/40%, 65%/35%, 70%/30%, 75%/25%, 80%/20%, 85%/15%, 90%/10% 95%/5%.

### BRIEF DESCRIPTION OF THE DRAWINGS

Other purposes, advantages and features will emerge from the description which follows, given for purely illustrative purposes and made with reference to the appended drawing wherein:

FIG. 1 is a side view of a high-pressure compressor casing including a shell partially covered with a covering layer obtained according to a manufacturing method according to the invention.

### DETAILED DESCRIPTION OF AT LEAST ONE EMBODIMENT

In what follows, the limits of a domain of values are comprised in this domain, in particular in the expression “comprised between”.

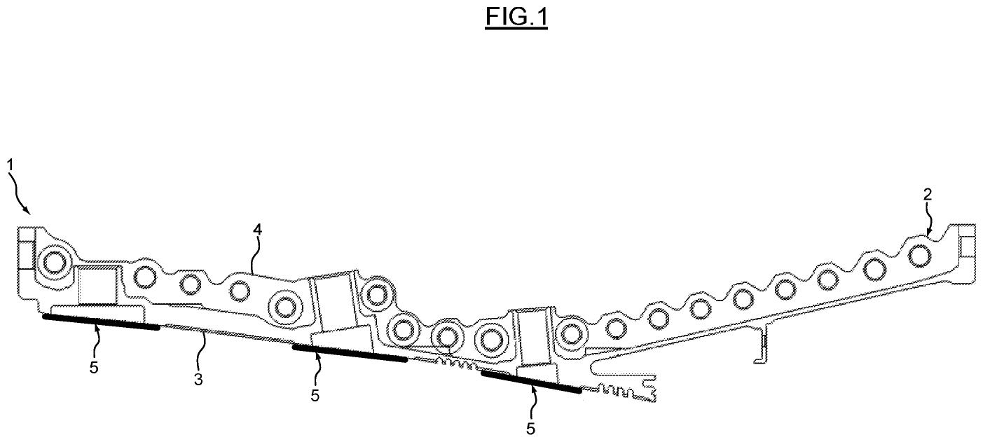

FIG. 1 illustrates a method for manufacturing a metal component 1 according to the invention.

The metal component 1 can, for example, be a casing shell of a high-pressure compressor for a turbomachine.

First, a titanium shell 2 is provided. Titanium shell or titanium-based material means an alloy wherein titanium is the major element. The terms “titanium”, “titanium alloy” or “titanium-based material” designate both quasi-pure titanium or a titanium alloy.

According to an exemplary embodiment, the shell 2 can be made of a TA6V alloy, of formula Ti6Al4V.

The shell 2 has a first surface 3 and a second surface 4 opposite the first surface 3.

A covering layer 5 made of a titanium fire-resistant material is then produced by additive manufacturing on the shell 2 such that said covering layer 5 partially or entirely covers the first surface 3 and/or the second surface 4.

Of course, provision could be made for a plurality of covering layers 5 to be produced on the first surface 3 and/or the second surface 4.

As can be seen in FIG. 1, the shell 1 may comprise a plurality of covering layers 5 so that the first surface is partially covered.

According to the example illustrated, the component 1 being a casing shell of a high-pressure compressor corresponding to a succession of a defined number of stationary blades and moving blades, the covering layers 5 could advantageously be disposed at least on all the areas of the casing opposite the moving blades.

According to an alternative, the entire internal surface of the casing can be covered with a covering layer 5.

The covering layer 5 can be a steel or an alloy.

According to one embodiment, the covering layer 5 can be made of Inconel®, preferably INCO 718, of formula NiCr19Fe19Nb5Mo3.

The additive manufacturing method can advantageously be selected from the following methods: surfacing by laser deposition called “Laser Metal Deposition” (LMD) in powder or wire form, additive manufacturing by electric arc called “Cold Metal Transfer” (CMT), or else Cold Spray.

The aforementioned additive manufacturing methods allow to obtain a covering layer 5 that is locally uniform and the thickness of which can be optimized.

In addition, the thickness of the covering layer is preferably of between 1 and 10 mm. The thickness may vary depending on the area of the shell 2 on which the covering layer 5 is applied.

After the additive manufacturing step, a heat treatment is carried out on the shell 2 at a temperature of between 200° C. and 1000° C. in order to give the covering layer 5 the mechanical properties necessary for the metal component 1 manufactured for its use.

Preferably, the heat treatment temperature will be selected so as not to degrade the mechanical resistance properties of the shell 2. In the example illustrated, the shell 2 is made of TA6V, a material for which the maximum applicable heat treatment temperature is for example 940° C.

The heat treatment may comprise one step or a plurality of steps.

According to one embodiment, the heat treatment may comprise two steps.

The heat treatment may advantageously comprise a first step at a temperature of between 500° C. and 1000° C., preferably of between 700° C. and 1000° C., and more preferably of between 930° C. and 950° C.

The first step can be carried out for a duration of between 10 min and 5 h, preferably of between 30 min and 2 h, and more preferably of between 45 min and 1 h 30 min.

Preferably, the heat treatment comprises a second step at a temperature of between 200° C. and 900° C., preferably of between 500° C. and 800° C. and more preferably of between 690° C. and 710° C.

The second step can be carried out for a duration of between 30 min and 9 h, preferably of between 6 h and 9 h, more preferably of between 7 h 30 and 8 h 30.

The second step will preferably be implemented at a temperature lower than the temperature of the first step, and carried out for a longer duration than the first step.

In order to improve the adhesion properties of the surfacing, that is to say of the covering layer 5 on the shell 2, the manufacturing method may further comprise the production of an intermediate layer made of a transition material disposed between the shell 2 made of a titanium-based material and the covering layer 5.

The transition material is advantageously selected so that it is attached both to the shell 2 and to the covering layer 5 made of a titanium fire-resistant material.

According to another embodiment, the adhesion properties can be improved thanks to a composition gradient. The manufacturing method may then comprise a step of producing a plurality of intermediate layers disposed between the shell 2 and the covering layer 5.

The intermediate layers are formed of a mixture of the titanium fire-resistant material and the titanium-based material and the mixture forms a composition gradient such that the intermediate layer disposed directly in contact with the covering layer 5 is mainly formed of the titanium fire-resistant material. Conversely, the intermediate layer disposed directly in contact with the shell 2 made of a titanium-based material is mainly formed of the titanium-based material.

Preferably, the number of intermediate layers is comprised between four and twenty layers, and more preferably between ten and fifteen layers.

Advantageously, the intermediate layers can be three in number. Each of the three layers made of titanium-based material, may for example comprise, respectively starting from the shell 2 towards the covering layer 5, that is to say from the innermost layer towards the outermost layer, an increasing proportion of titanium fire-resistant material.

The transition area formed by the composition gradient thus allows progressive adhesion of the titanium fire-resistant material.

Examples of the Method for Manufacturing a Metal Component According to the Invention:

### EXAMPLE 1

### Direct Surfacing

From a casing 1 shell 2 of a high-pressure compressor for a turbomachine is made of a TA6V alloy, of formula Ti6Al4V, a covering layer 5 made of a titanium fire-resistant material, INCO 718, of formula NiCr19Fe19Nb5Mo3, is formed by additive manufacturing.

The covering layer 5 is produced according to the method of surfacing by laser deposition (Laser Metal Deposition) in powder form.

The covering layer 5 is made so that it partially covers the first surface 3 of the shell 2. In addition, the thickness of the covering layer 5 is of between 1 and 10 mm.

After the additive manufacturing step, the shell 2 is heat treated in two steps.

A first step is carried out at a temperature of 940° C. for 1 hour then a second step at a temperature of 700° C. for 8 hours.

This heat treatment is particularly advantageous for imparting sufficient mechanical resistance properties to the TA6V and thus maintaining the mechanical resistance of the casing. The thickness of the covering layer contributing very little to the mechanical resistance of the casing, the partial degradation of the mechanical properties of INCO 718 is acceptable.

### EXAMPLE 2

### Surfacing with Transition Material

From a casing 1 shell 2 of a high-pressure compressor for a turbomachine, made of a TA6V alloy, an intermediate layer is formed of a transition material, by additive manufacturing.

The intermediate layer is produced by the method of surfacing by laser deposition in powder form. The intermediate layer is disposed on the shell 2 so that the transition material partially covers the first surface 3 of the shell 2.

A covering layer 5 made of INCO 718 is then produced by the method of surfacing by laser deposition in powder form, so that the covering layer 5 covers the transition material. The thickness of the covering layer 5 is of between 1 and 10 mm.

After the additive manufacturing step, a heat treatment identical to Example 1 is carried out.

### EXAMPLE 3

### Surfacing with Composition Gradient

As described in Example 1, a casing 1 shell 2 of a high-pressure compressor for a turbomachine made of a TA6V alloy, of formula Ti6Al4V, is provided.

A composition gradient is then formed including three intermediate layers so that they partially cover the first surface 3 of the shell 2.

The three layers comprise, starting from the TA6V shell 2 towards the covering layer 5 made of INCO 718, an increasing proportion of INCO 718 material. In this example, the INCO 718/TA6V proportions starting from the TA6V shell 2 towards the covering layer 5 made of INCO 718 are: 30%/70%, 50%/50% and 70%/30%.

Then, the covering layer 5 made of a titanium fire-resistant material, INCO 718, of formula NiCr19Fe19Nb5Mo3, is produced by the method of surfacing by laser deposition in powder form on the intermediate layers. The thickness of the covering layer 5 is of between 1 and 10 mm.

After the additive manufacturing step, a heat treatment identical to Example 1 is carried out.

### EXAMPLE 4

### Surfacing with Composition Gradient

As described in Example 1, a casing 1 shell 2 of a high-pressure compressor for a turbomachine made of a TA6V alloy, of formula Ti6Al4V, is provided.

A composition gradient is then formed including nine intermediate layers so that they partially cover the first surface 3 of the shell 2.

The nine layers comprise, starting from the TA6V shell 2 towards the covering layer 5 made of INCO 718, an increasing proportion of INCO 718 material. In this example, the INCO 718/TA6V proportions starting from the TA6V shell 2 towards the covering layer 5 made of INCO 718 are: 10%/90%, 20%/80%, 30%/70%, 40%/60%, 50%/50%, 60%/40%, 70%/30%, 80%/20%, 90%/10%.

Then, the covering layer 5 made of a titanium fire-resistant material, INCO 718, of formula NiCr19Fe19Nb5Mo3, is produced by the method of surfacing by laser deposition in powder form on the intermediate layers. The thickness of the covering layer 5 is of between 1 and 10 mm.

After the additive manufacturing step, a heat treatment identical to Example 1 is carried out.

### EXAMPLE 5

### Surfacing with Composition Gradient

As described in Example 1, a casing 1 shell 2 of a high-pressure compressor for a turbomachine made of a TA6V alloy, of formula Ti6Al4V, is provided.

A composition gradient is then formed including nineteen intermediate layers so that they partially cover the first surface 3 of the shell 2.

The nineteen layers comprise, starting from the TA6V shell 2 towards the covering layer 5 made of INCO 718, an increasing proportion of INCO 718 material. In this example, the INCO 718/TA6V proportions starting from the TA6V shell 2 towards the covering layer 5 made of INCO 718 are: 5%/95%, 10%/90%, 15%/85%, 20%/80%, 25%/75%, 30%/70%, 35%/65%, 40%/60%, 45%/55%, 50%/50%, 55%/45%, 60%/40%, 65%/35%, 70%/30%, 75%/25%, 80%/20%, 85%/15%, 90%/10% 95%/5%. Then, the covering layer 5 made of a titanium fire-resistant material, INCO 718, of formula NiCr19Fe19Nb5Mo3, is produced by the method of surfacing by laser deposition in powder form on the intermediate layers. The thickness of the covering layer 5 is of between 1 and 10 mm.

After the additive manufacturing step, a heat treatment identical to Example 1 is carried out.

### EXAMPLE 6

### Surfacing with Composition Gradient

As described in Example 1, a casing 1 shell 2 of a high-pressure compressor for a turbomachine made of TA6V alloy, of formula Ti6Al4V, is provided.

A composition gradient is then formed including three intermediate layers so that they partially cover the first surface 3 of the shell 2.

The three layers comprise, starting from the TA6V shell 2 towards the covering layer 5 made of INCO 718, an increasing proportion of INCO 718 material. In this example, the INCO 718/TA6V proportions starting from the TA6V shell 2 towards the covering layer 5 made of INCO 718 are: 25%/75%, 50%/50%, 75%/25%.

Then, the covering layer 5 made of a titanium fire-resistant material, INCO 718, of formula NiCr19Fe19Nb5Mo3, is produced by the method of surfacing by laser deposition in powder form on the intermediate layers. The thickness of the covering layer 5 is of between 1 and 10 mm.

After the additive manufacturing step, a heat treatment identical to Example 1 is carried out.

1. A method for manufacturing a metal component, comprising the following steps:
providing a shell of a titanium-based material, the shell having a first surface and a second surface opposite the first surface;
producing, via additive manufacturing, a covering layer made of a titanium fire-resistant material that at least partially covers the first surface and/or the second surface; and
after the additive manufacturing step, heat treating the metal component at a temperature of between 200° C. and 1000° C.;
producing a plurality of intermediate layers disposed between the shell and the covering layer, the plurality of intermediate layers being formed of a mixture of the titanium fire-resistant material and the titanium-based material, said mixture forming a composition gradient such that the intermediate layer disposed directly in contact with the covering layer made of a titanium fire-resistant material is mainly formed of the titanium fire-resistant material and conversely, the intermediate layer disposed directly in contact with the shell made of a titanium-based material being mainly formed of the titanium-based material.

2. The manufacturing method according to claim 1, wherein said covering layer is made of a material of formula NiCr19Fe19Nb5Mo3 and/or the shell is made of a material of formula Ti6Al4V.

3. The manufacturing method according to claim 1, wherein the heat treatment comprises a plurality of steps.

4. The manufacturing method according to claim 1, wherein the heat treatment comprises a first step at a temperature of between 500° C. and 1000° C.

5. The manufacturing method according to claim 4, wherein the first step is carried out for a duration of between 10 minutes and 5 hours.

6. The manufacturing method according to claim 4, wherein the heat treatment comprises a second step at a temperature of between 200° C. and 900° C.

7. The manufacturing method according to claim 6, wherein the second step is carried out for a duration of between 30 minutes and 9 hours.

8. The manufacturing method according to claim 1, wherein the thickness of the covering layer is between 1 mm and 10 mm.

9. The manufacturing method according to claim 1, wherein the additive manufacturing is selected from the following methods: surfacing by laser deposition called Laser Metal Deposition (LMD) in powder or wire form, additive manufacturing by electric arc called Cold Metal Transfer (CMT), or Cold Spray.

10. The manufacturing method according to claim 1, comprising the production of an intermediate layer made of a transition material disposed between the shell and the covering layer.

11. The manufacturing method according to claim 1, wherein the number of the plurality of intermediate layers is comprised between 4 and 20 layers.

12. The manufacturing method according to claim 1, wherein the plurality of intermediate layers comprises three layers, the three layers comprising, starting from the shell towards the covering layer, an increasing proportion of titanium fire-resistant material.

13. The manufacturing method according to claim 1, wherein the shell made of a titanium-based material is a casing shell of a high-pressure compressor for a turbomachine.

14. The manufacturing method according to claim 4, wherein the first step of heat treatment is carried out at a temperature selected from a group of temperature ranges consisting of between 700° C. and 1000° C., and between 930° C. and 950° C.

15. The manufacturing method according to claim 5, wherein the first step is carried out for a duration selected from a group of durations consisting of between 30 minutes, and 2 hours and 45 minutes and 1 hour 30 minutes.

16. The manufacturing method according to claim 6, wherein the second step of heat treatment is carried out at a temperature selected from a group of temperature ranges consisting of between 500° C. and 800° C. and between 690° C. and 710° C.

17. The manufacturing method according to claim 7, wherein the second step is carried out for a duration selected from a group of durations consisting of between 6 hours and 9 hours, and 7 hours 30 minutes and 8 hours 30 minutes.
